(19) United States
(12) Patent Application Publication
(10) Pub. No.: US 2020/0295345 A1
(43) Pub. Date: Sep. 17, 2020

(54) METHOD OF MANUFACTURING ELECTROCHEMICAL DEVICE AND ELECTRODES FOR ELECTROCHEMICAL DEVICE

(71) Applicant: NEC ENERGY DEVICES, LTD., Sagamihara-shi, Kanagawa (JP)

(72) Inventors: Masanori HIRAI, Sagamihara-shi (JP); Kenji SATO, Sagamihara-shi (JP)

(73) Assignee: NEC ENERGY DEVICES, LTD., Sagamihara-shi, Kanagawa (JP)

(21) Appl. No.: 16/083,926

(22) PCT Filed: Dec. 26, 2016
(86) PCT No.: PCT/JP2016/088709

§ 371 Date: Sep. 11, 2018

(30) Foreign Application Priority Data
Mar. 11, 2016 (JP) 2016-048838

(51) Int. Cl. H01M 4/04; H01G 11/86; H01M 10/0585

(52) U.S. Cl. CPC H01M 4/0404; H01M 10/0585; H01G 11/86

(57) ABSTRACT

A method of manufacturing electrodes for an electrochemical device in which each of electrodes comprises a current collector 9, 11 and active material layers 10, 12 using four die heads 15a-15d is described. The active material layers 10, 12 each contains a lower active material layer 10a, 12a and an upper active material layer 10b, 12b. While the current collector 9, 11 is being conveyed, a slurry is ejected from the die head 15a that is on the most upstream side in the direction of conveyance S and the die head 15b located on the second from the upstream side to form the lower active material layers 10a, 12a of two electrodes, and a slurry is ejected from the die head 15c located on the third from the upstream side and the die head 15d located on the fourth from the upstream side to form the upper active material layers 10b, 12b of two electrodes.

### TECHNICAL FIELD

The present invention relates to a method of manufacturing an electrochemical device and electrodes for electrochemical device.

### BACKGROUND ART

Laminated-type electrochemical devices are one type of electrochemical devices such as secondary batteries are widely used as electric power sources of, cellular phones, digital still cameras, laptop computers, electric vehicles and home energy storage systems.

A laminated-type electrochemical device comprised of a multilayered electrode body in which a plurality of positive electrodes, a plurality of negative electrodes and a plurality of separators that separates each pair of the positive electrode and the negative electrode.

The electrode sheets for an electrochemical device are comprised of coated portions which are coated with an active material on a current collector and non-coated portions where the active material is not coated, and the non-coated portions is connected to an electrode terminal. A conductive auxiliary agent and/or a binder may also be coated.

In a laminated-type electrochemical device, the multilayered electrode body is sealed within an outer case. One end of a positive electrode terminal is electrically connected to the non-coated portions of positive electrode sheets and the other end is led out to the exterior of the outer case, and one end of a negative electrode terminal is electrically connected to non-coated portions of negative electrode sheets and the other end is led out to the exterior of the outer case. Electrolyte is sealed inside the outer case together with the multilayered electrode body.
a capacity of a secondary battery is on the increase year by year, and a quantity of heat generated in the event of a short circuit also increases.
So, secondary batteries are demanded to be further taken measures to meet safety.

One example of such a safety measure is a construction in which insulating members are arranged on the boundary portions of coated portions and non-coated portions. It contributes to prevent short circuits between positive electrodes and negative electrodes. However, quality problems of the electrochemical device such as a decrease of energy density per unit volume, a fluctuation of some electric characteristics, or a decrease of a capacity retention rate in a charge-discharge cycles might be happened.

A partial thickness increase of the electrode by setting an insulating member such as a tape bring about the problems because it is unable to pressure the laminated electrodes uniformly. Therefore, there is some configurations preventing or reducing the partial thickness increase of the electrode by partially thinning the thickness of the end portions of the active material layers and then arranging insulating members over these thinned portions and non-coated portions.

A typical method of manufacturing electrodes for a laminated-type electrochemical device comprises a step of ejecting a fluid slurry containing active material from a die head to a current collector, and a step of forming active material layers by intermittently ejecting slurry from a die head to a current collector in the form of a long sheet by moving the current collector with respect to the die head. After the above-described manufacturing step, individual electrodes are obtained by cutting the current collector on which the active material layers have been formed. Because of repeated go and break process of ejecting slurry, it is more difficult to increase the application speed in an intermittent coating process that eject the active material slurry from a die head to a current collector than a continuous coating process, and unreasonably speed-up in an intermittent coating process complicates formation control of the end portions of the active material layers.

In Patent Document 1, an active material layer is given a two-layer construction to control the form of the electrode end portions, and insulating members are arranged on single-layer portions in which only a lower active material layer is present. This configuration realizes preventing partial increase of the thickness of the electrode multilayer body.

Patent Document 2 discloses a technique of using a plurality of die heads to form a multilayered film.

Patent Document 3 discloses a manufacturing method in which a plurality of die heads is used to intermittently form electrodes.

### PRIOR ART DOCUMENTS

### Patent Documents

Patent Document 1: WO2015/087657A
Patent Document 2: JP2000-185254A
Patent Document 3: JPH10-015463A

### SUMMARY OF THE INVENTION

### Problem to be Solved by the Invention

When an active material-containing slurry is intermittently ejected from a die head to a current collector, ejection of the slurry from the die head is stopped for one time and then ejection of the slurry is resumed. This process require time to operate the mechanism to open and close the valve for supplying slurry into the die head and time to move the die head closer toward and away from the current collector. Hence, control of the end portion shape in intermittent coating process becomes even more difficult in the case of high-speed conveyance of the current collector foil. Although Patent Document 1 discloses a technique of forming electrodes in multiple layers to create points at which insulating members are provided at end portions, no consideration is given to the improvement of production efficiency. Patent Document 2 regards only the formation of electrodes in multiple layers and gives no consideration to controlling the shape.

In the invention disclosed in Patent Document 3, moreover, an active material of single-layer construction can be formed at high speed, but thinned portions cannot be formed with dimensional precision at high speed.

It is therefore a purpose of the present invention to provide a solution to the above-described problem by providing a method of manufacturing an electrode for an electrochemical device. And it results in both an improvement of production efficiency by a reduction of the manufacturing time and reduction of manufacturing costs by a decrease of discarded portions. Further, formation of thinned portions with dimensional precision in the active material layers of electrodes is realized by the present invention.

### Means for Solving the Problem

According to the present invention, a method of manufacturing electrodes for electrochemical device in which the electrode comprises a current collector and active material layers, wherein the active material layers comprise a lower active material layer formed on the current collector and an upper active material layer formed on the lower active material layer, using at least four die heads that are arranged in a row along the direction of conveyance of the current collector and arranged onto the current collector is provided. The lower active material layers of two electrodes are formed while conveying the current collector by ejecting an active material-containing slurry onto the current collector from the die head on the most upstream side in the direction of conveyance and ejecting the slurry onto the current collector from the die head located on the second from the upstream side in the direction of conveyance, and the upper active material layers of two electrodes are formed by both ejecting the slurry onto the current collector from the die head located on the third from the upstream side in the direction of conveyance and ejecting slurry onto the current collector from the die head located on the fourth from the upstream side in the direction of conveyance.

### Effects of the Invention

The present invention enables a shortening operation time for manufacturing electrodes and enables an improving manufacturing efficiency. In addition, the present invention can reduce the discarded portions thereby decreasing manufacturing costs to a lower level. Still further, the present invention allows the formation of thinned portions with precise dimensions in the active material layers of electrodes.

### BRIEF DESCRIPTION OF THE DRAWINGS

FIG. 1a is a top view showing a secondary battery that is one example of an electrochemical device of the present invention.

FIG. 1b is a cross-sectional view taken along line A-A of FIG. 1a.

FIG. 2 is an enlarged view showing the principal parts of a positive electrode of the secondary battery shown in FIGS. 1a and 1b.

FIG. 3 is an enlarged view showing the principal parts of a negative electrode of the secondary battery shown in FIGS. 1a and 1b.

FIG. 4 is a schematic view showing a coating device that is used in the method of manufacturing electrodes for an electrochemical device of the present invention.

FIG. 5a is an explanatory view giving a schematic representation of a portion of the formation procedure of the active material layer of the positive electrode shown in FIG. 2.

FIG. 5b is an explanatory view giving a schematic representation of the procedure that follows FIG. 5a.

FIG. 5c is an explanatory view giving a schematic representation of the procedure that follows FIG. 5b.

FIG. 5d is an explanatory view giving a schematic representation of the procedure that follows FIG. 5c.

FIG. 5e is an explanatory view giving a schematic representation of the procedure that follows FIG. 5d.

FIG. 5f is an explanatory view giving a schematic representation of the procedure that follows FIG. 5e.

FIG. 6a is an explanatory view giving a schematic representation of a portion of a modification of the formation procedure of the active material layer of the positive electrode shown in FIG. 2.

FIG. 6b is an explanatory view giving a schematic representation of the procedure that follows FIG. 6a.

FIG. 6c is an explanatory view giving a schematic representation of the procedure that follows FIG. 6b.

FIG. 6d is an explanatory view giving a schematic representation of the procedure that follows FIG. 6c.

FIG. 6e is an explanatory view giving a schematic representation of the procedure that follows FIG. 6d.

FIG. 6f is an explanatory view giving a schematic representation of the procedure that follows FIG. 6e.

FIG. 6g is an explanatory view giving a schematic representation of the procedure that follows FIG. 6f.

FIG. 7a is an explanatory view giving a schematic representation of a portion of another exemplary embodiment of the formation procedure of the active material layer of the positive electrode shown in FIG. 2.

FIG. 7b is an explanatory view giving a schematic representation of the procedure that follows FIG. 7a.

FIG. 7c is an explanatory view giving a schematic representation of the procedure that follows FIG. 7b.

FIG. 7d is an explanatory view giving a schematic representation of the procedure that follows FIG. 7c.

FIG. 7e is an explanatory view giving a schematic representation of the procedure that follows FIG. 7d.

FIG. 7f is an explanatory view giving a schematic representation of the procedure that follows FIG. 7e.

FIG. 8 is a schematic view showing another example of the coating device used in the manufacturing method of electrodes for an electrochemical device of the present invention.

### EXEMPLARY EMBODIMENTS OF THE INVENTION

Exemplary embodiments of the present invention are described with reference to the accompanying drawings.

### Secondary Battery Configuration

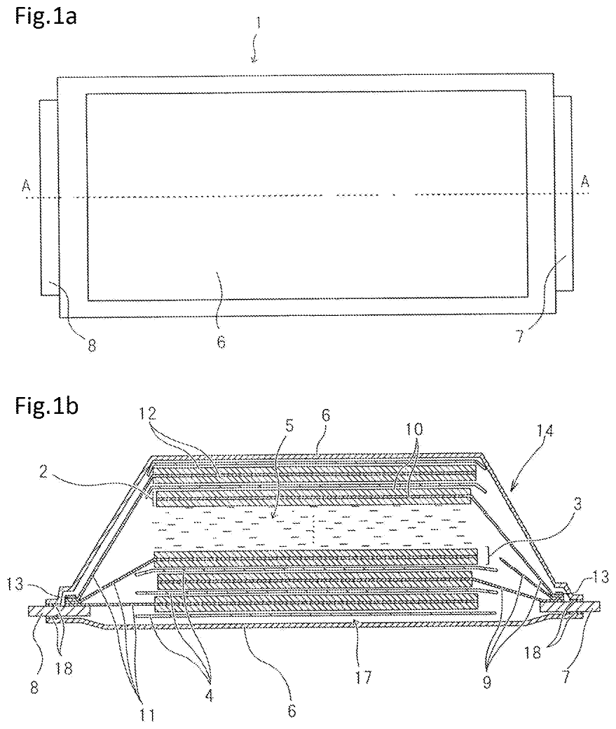

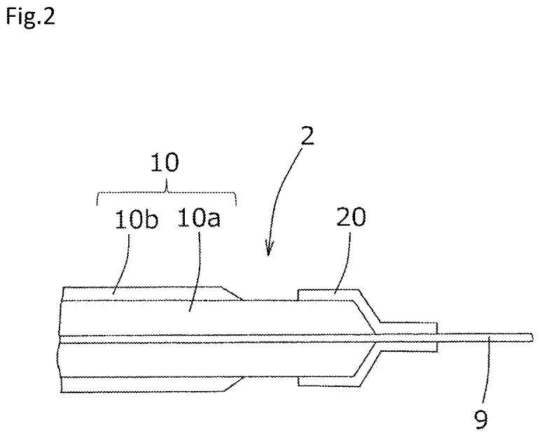

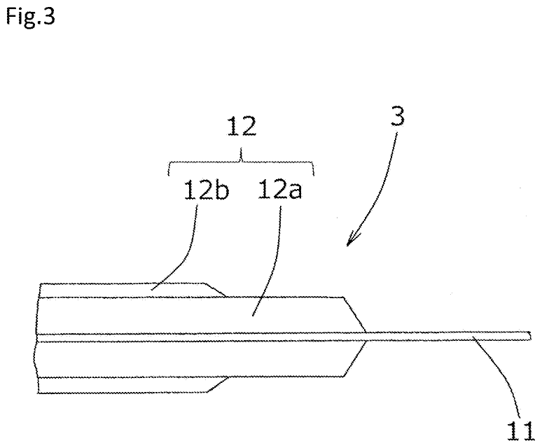

FIGS. 1a and 1b give schematic representations of secondary battery 1 that is an example of the electrochemical device manufactured according to the present invention. FIG. 1a is a top view as seen from perpendicularly above the principal surface of secondary battery 1, and FIG. 1b is a cross-sectional view taken along line A-A of FIG. 1a. FIG. 2 is an enlarged view of positive electrode 2, and FIG. 3 is an enlarged view of negative electrode 3.

Secondary battery 1 of the present exemplary embodiment is provided with multilayered electrode body 17 in which electrodes of two types, i.e., positive electrodes 2 and negative electrodes 3 are alternately laminated on each other with separators 4 interposed therebetween. This multilayered electrode body 17 is accommodated together with electrolyte 5 in the interior of outer case 14 that is made up from flexible film 6. One end portion of positive electrode terminal 7 is connected to positive electrodes 2 of multilayered electrode body 17 and one end portion of negative electrode terminal 8 is connected to negative electrodes 3. The other end portion of positive electrode terminal 7 and the other end portion of negative electrode terminal 8 are drawn out to the exterior of outer case 14. In FIG. 1b, the layers positioned in the central portion in the direction of thickness are omitted from the figure and electrolyte 5 is shown. Although positive electrodes 2, negative electrodes 3, separators 4, and flexible film 6 are shown as not being in contact with each other in FIG. 1b in the interest of clarity, these components are laminated in close contact with each other.

Either or both of positive electrodes 2 and negative electrodes 3 comprise two or more layers of active material layers.

Each of positive electrodes 2 comprises positive electrode current collector 9, and positive electrode active material layer 10 coated on positive electrode current collector 9. There are coated portion in which positive electrode active material layer 10 is formed and non-coated portion in which positive electrode active material layer 10 is not formed, on the obverse surface and reverse surface of positive electrode current collector 9. Although not shown in detail in FIGS. 1a and 1b, when positive electrode active material layer 10 is made up by two layers, the positive electrode active material layer comprises two-layer portion in which lower active material layer 10a and upper active material layer 10b are stacked and a single-layer portion which is composed of only lower active material layer 10a and in which upper active material layer 10b is not present, as shown in FIG. 2. Similarly, negative electrodes 3 shown in FIG. 3 each comprises a negative electrode current collector 11 and negative electrode active material layer 12 coated on negative electrode current collector 11. There are coated portions and non-coated portions on the obverse surfaces and reverse surfaces of negative electrode current collector 11. When negative electrode active material layer 12 is made up by two layers, the negative electrode active material layer 12 comprises a two-layer portion in which lower active material layer 12a and upper active material layer 12b are stacked and a single-layer portion made up from only lower active material layer 12a. Then, as shown in FIG. 2, tape-shaped insulating member 20 adheres to boundary portion between the single-layer portion 10a and non-coated portion 9. Insulating member 20 can be made to have a thickness substantially equal to upper active material layer 10b or less. In the present exemplary embodiment, insulating members 20 are provided on positive electrodes 2, but insulating members 20 may also be provided on negative electrodes 3, or insulating members 20 may be provided on both positive electrodes 2 and negative electrodes 3.

Each of the non-coated portions 9 and 11 is respectively used as positive electrode tab and negative electrode tab for connecting with positive electrode terminal 7 and negative electrode terminal 8. In the case of FIG. 1b, non-coated portions of positive electrode current collectors 9 are gathered together on one end portion of positive terminal 7 to form a collection part, and this collection part is interposed between metal tab 13 and positive terminal 7, and these parts are connected by, for example, ultrasonic welding at the point at which these parts overlap each other. Similarly, non-coated portions of negative electrode current collector 11 are gathered together on one end portion of negative electrode terminal 8 to form a collection part, this collection part is interposed between metal tab 13 and negative electrode terminal 8, and these parts are connected by, for example, ultrasonic welding at the point at which these parts overlap each other. The other end portion of positive electrode terminal 7 and the other end portion of negative electrode terminal 8 each extend to the exterior of outer case 14 that is made up from flexible film 6.

The outer dimensions of the negative electrode active material layers 12 are preferably larger than positive electrode active material layers 10 and preferably equal to or smaller than the outer dimensions of separators 4.

In film-sheathed secondary battery 1, multilayered electrode body 17 is covered by flexible film 6 from both sides of the principal surfaces and overlapping flexible film 6 is bonded together and sealed at the outer sides of the outer peripheries of multilayered electrode body 17. In this way, outer case 14 that accommodates multilayered electrode body 17 and electrolyte 5 is formed. Typically, flexible film 6 is a laminated film in which resin layers are provided on both sides of metal foil that is a substrate, at least the resin layer on the inner side being made up from thermally fusible resin such as modified polyolefin. The resin layers of the inner sides that are composed of thermally fusible resin are then heated in a state of being in direct contact with each other and are thus fused together to realize heat welding and form outer case 14 in which the outer circumference is sealed.

Materials that can be considered as the active material that makes up positive electrode active material layers 10 in secondary battery of the present exemplary embodiment include, for example, a layered oxide-based material such as LiCoO₂, LiNiO₂, LiMn₂O₂, Li₂MO₃—LiMO₂, or LiNi_{1/3}Co_{1/3}Mn_{1/3}O₂; a spinel-based material such as LiMn₂O₄; an olivine-based material such as LiMPO₄; an olivine-fluoride-based material such as Li₂MPO₄F or Li₂MSiO₄F; and a vanadium-oxide-based material such as V₂O₅. In each of the positive electrode active materials, a portion of the elements that make up these active materials may be replaced by another element, or Li may be an excess component. Alternatively, a mixture of one, two, or more types among these active materials can be used.

Materials that can be used as the active material that makes up negative electrode active material layers 12 include carbon materials such as graphite, amorphous carbon, diamond-like carbon, fullerene, carbon nanotube, and carbon nanohorn; a lithium metal material; an alloy material such as silicon or tin; an oxide-based material such as Nb₂O₅ or TiO₂; or a composite of any of these materials.

The active material mixture that makes up positive electrode active material layers 10 and negative electrode active material layers 12 is a substance in which a binding agent or conductive auxiliary agent has been added as appropriate to each of the precedingly described active materials. One or a combination of two or more of carbon black, carbon fibers, and graphite can be used as the conductive auxiliary agent. In addition, polyvinylidene fluoride, polytetrafluoroethylene, carboxymethyl cellulose, styrene-butadiene rubber, and modified acrylonitrile rubber particles can be used as the binding agent.

In either of positive electrode active material layers 10 and negative electrode active material layers 12, the unavoidable inclination, unevenness, or curvature in each layer that arise due to layer formation capabilities or variations in manufacturing processes present no problem.

Aluminum, stainless steel, nickel, titanium, or an alloy of these metal can be used as positive electrode current collectors 9, but aluminum is preferable. Copper, stainless steel, nickel, titanium, or an alloy of these metals can be used as negative electrode current collectors 11.

As electrolyte 5, one or a mixture of two or more can be used from among organic solvents such as cyclic carbonates such as ethylene carbonate, propylene carbonate, vinylene carbonate, and butylene carbonate; chain carbonates such as ethyl methyl carbonate (EMC), diethyl carbonate (DEC), dimethyl carbonate (DMC), and dipropyl carbonate (DPC); aliphatic carboxylic acid esters; γ-lactones such as γ-butyrolactone; chain ethers; and cyclic ethers. Further, lithium salt can also be dissolved in these organic solvents.

Separators 4 are chiefly composed of porous film, woven fabric, or nonwoven fabric made of resin, and materials that can be used as the resin component include, for example, polyolefin resins such as polypropylene and polyethylene, polyester resins, acryl resins, styrene resins, nylon resins, aromatic polyamide resins, and polyimide resins. A polyolefin-based microporous film is particularly preferable due to its excellent ion permeability and its capacity to physically isolate positive electrodes and negative electrodes. In addition, a layer that comprises inorganic particles may also be formed on separators 4. Materials that can be considered as the inorganic particles include insulative oxides, nitrides, sulfides, and carbides, and of these, materials that contain TiO₂ or Al₂O₃ are preferable.

Outer case 14 is a lightweight outer case composed of flexible film 6, and flexible film 6 is a laminated film provided with a metal foil that is a substrate and with resin layers on both sides of the metal foil. As the metal foil, a material can be selected that has a barrier capability to prevent leakage of electrolyte 5 or the influx of moisture from the outside, and materials such as aluminum and stainless steel can be used. A thermally fusible resin layer such as modified polyolefin is provided on at least one surface of the metal foil. The thermally fusible resin layers of flexible film 6 are arranged opposite each other, and outer case 14 is formed by thermally fusing the periphery of the portion that accommodates multilayered electrode body 17. A resin layer such as nylon film, polyethylene terephthalate film, or polyester film can be provided as the obverse surface of outer case 14 on the surface opposite the surface on which the thermally fusible resin layer is formed.

A material constituted by aluminum or an aluminum alloy can be used as positive electrode terminal 7. Materials that can be used as negative electrode terminal 8 include copper, copper alloy, a material in which copper or copper alloy has been subjected to nickel plating, and nickel. The end portions of the other sides of these terminals 7 and 8 are led out to the outside of outer case 14. Sealant 18 can be provided in advance on the sites of each of terminals 7 and 8 that correspond to the portions of the outer periphery of outer case 14 that are to be thermally fused.

Metal tabs 13 prevent damage to positive electrode current collector 9 or negative electrode current collector 11 and improve the reliability of connections between the electrode tabs and positive electrode terminal 7 or negative electrode terminal 8. Metal tabs 13 preferably are thin and strong and are provided with resistance to electrolyte 5. Preferable materials that can be considered for forming support tabs 13 include aluminum, nickel, copper, and stainless steel.

Insulating members 20 that are formed to cover the boundary portions of the coated portions and non-coated portions of the active material layers can be formed from polyimide, glass fibers, polyester, polypropylene, or a material that contains these materials. More specifically, insulating members 20 can be formed by applying heat to tape type resin members to fuse the resin members to the boundary portions, or by applying a resin in gel form to the boundary portions and then drying.

### Method of Manufacturing Secondary Battery

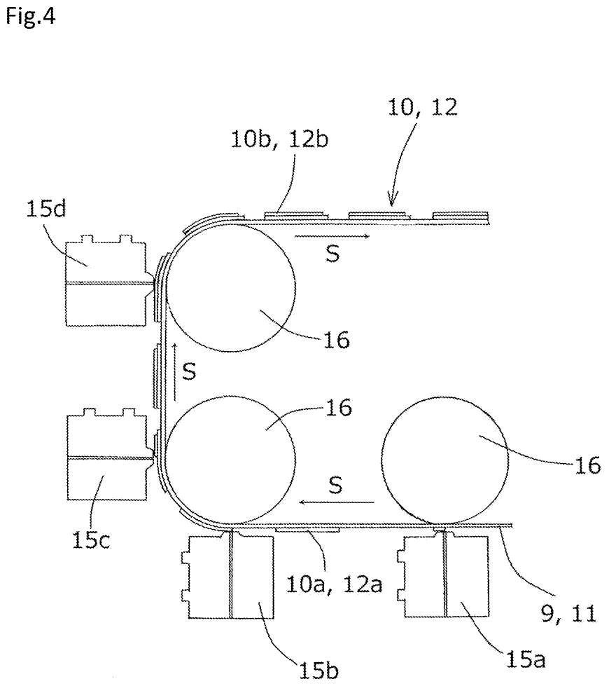

FIG. 4 is a schematic view showing the coating device used in the method of manufacturing electrodes for the electrochemical device of the present invention, and more specifically, gives a schematic representation of the coating portion of a die coater.

In the manufacture of secondary battery 1, as shown in FIG. 4, a die coater that comprises four die heads 15a, 15b, 15c, 15d and a conveyor device 16 for conveying a current collector 9 or 11 to pass positions that face the four die heads 15a, 15b, 15c, 15d are used to manufacture electrode 2, 3 shown in FIGS. 2 and 3.

In FIG. 4, each of die heads 15a, 15b, 15c, 15d is arranged to face their ejecting ports toward cylindrical back roll 16, and positive electrode current collector 9 or negative electrode current collector 11 is arranged between die heads 15a, 15b, 15c, 15d and back roll 16. The active material is coated when the current collector is conveyed in one direction, whereby the active material layer can be formed on the current collector along the longitudinal direction.

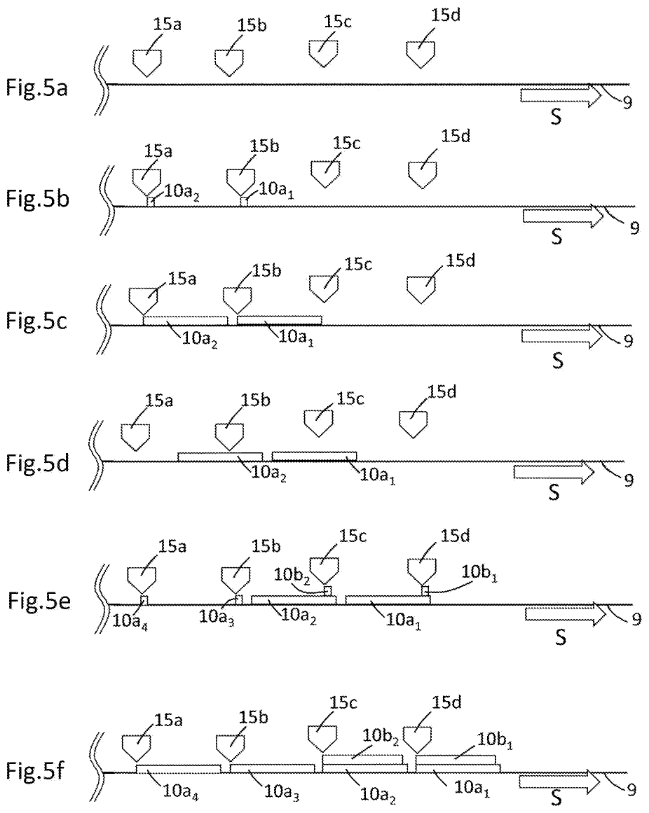

To form non-coated portions of intermittent coating satisfactorily, the ejecting ports are preferably arranged directed in a horizontal direction from above, but the direction of conveyance S of current collector 9 in FIGS. 5a-5f is schematically shown in linear form in the interest of facilitating understanding of the operation of each die head in FIG. 4. Referring to these figures, explanation is presented taking as an example the process of forming active material layers 10 of positive electrodes 2. Because the formation of active material layers 10 is carried out with two electrodes combined as one set in the present exemplary embodiment, explanation will focus on lower active material layer 10a₁ and upper active material layer 10b₁ formed on this lower active material layer 10a₁ at the portion to be preceding electrode and lower active material layer 10a₂ and upper active material layer 10b₂ formed on this lower active material layer 10a₂ at the portion to be next electrode. In each of the steps shown in FIGS. 5a-5f, current collector 9 on which these active material layers 10 are formed is shown in the process of moving in conveyance direction S.

In the present exemplary embodiment, while conveying positive electrode current collector 9 as shown in FIG. 5a, a fluid slurry containing positive active material is ejected toward current collector 9 from die head 15a located on the most upstream side in the direction of conveyance S and from die head 15b located on the second from the upstream side as shown in FIG. 5b. The speed of conveyance is preferably equal to or faster than 10 m/min, more preferably equal to or faster than 20 m/min, and still more preferably equal to or faster than 40 m/min. Even if the conveyance speed is slow, adoption of the present invention is expected to provide higher productivity and improved stability of the end portions of electrode, but higher speeds are preferable from the standpoint of production efficiency. Although no restriction is imposed on the upper limit of the speed, if the active material is formed in two layers by four heads and, for example, if the active material layer on one side of the current collector is formed to have the thickness of 200 μm or less, the speed of conveyance should preferably be set to 100 m/min or less.

The viscosity of the slurry is preferably 1000-15000 cp, and more preferably 3000-9000 cp. Viscosity that is too high degrades the following capability when ejection of the active material from the die heads is halted, and viscosity that is too low complicates maintaining of the form immediately after ejection and does not contribute to improving control of the end portion shape of the active material layer.

The slurry ejected from die head 15b forms lower active material layer 10a₁ of the preceding electrode, and further, the slurry ejected from die head 15a forms lower active material layer 10a₂ of the next electrode. When lower active material layers 10a₁ and 10a₂ of two electrodes have been completed as shown in FIG. 5c, current collector 9 is conveyed further as shown in FIG. 5d. Then, when lower active material layers 10a₁ and 10a₂ reach positions opposite each of die heads 15c and 15d as shown in FIG. 5e, slurry is ejected from die head 15c located on the third from the upstream side and die head 15d located on the fourth from the upstream side. As shown in FIG. 5f, upper active material layer 10b₁ of the preceding electrode is formed by the slurry ejected from the fourth die head 15d from the upstream side, and upper active material layer 10b₂ of the next electrode is formed by slurry ejected from the third die head 15c from the upstream side. During this time interval, lower active material layers 10a₃ and 10a₄ of the following two electrodes can be formed.

In this way, positive electrode active material layers 10 of the two-layer structure shown in FIG. 2 are formed. By slightly shifting the start point of the application of upper active material layer 10b from the start point of the application of lower active material layer 10a, a single-layer portion composed only of lower active material layer 10a is formed without the presence of upper active material layer 10b, on the side of start point of the application. In other words, the start point of the application of upper active material layer 10b is positioned on lower active material layer 10a. Insulating member 20 is put on the boundary of the single-layer portion formed in this way and non-coated portion 9.

For convenience, explanation has here focused on the method of manufacturing positive electrode active material layers 10 of two positive electrodes 2, but a multiplicity of positive electrode active material layers 10 of two-layer structure are formed by continuing the steps described above. Then, although not shown in the figures, positive electrode active material layers 10 of two-layer structure are also formed on the reverse side of positive electrode current collector 9 like each of the steps shown in FIGS. 5a-5f. Positive electrode current collector 9 is subsequently cut for each positive electrode active material layer 10 to obtain a plurality of positive electrodes 2 as shown in FIG. 2. Further, negative electrode active material layers 12 which have a two-layer structure are formed on both sides of negative electrode current collector 11 by steps like above-described and complete negative electrodes 3 as shown in FIG. 3. Insulating members 20 are not arranged on negative electrodes 3.

According to the method of manufacturing the electrodes of the present exemplary embodiment described hereinabove, one die head ejects slurry to form the active material layer of one electrode, while another die head ejects slurry to form the active material layer of the next electrode. Hence, the manufacturing time is shortened, and discarded current collector portion is reduced. It results in the manufacturing cost being reduced to a low level.

In the present exemplary embodiment, moreover, the lower active material layer and the upper active material layer are formed by slurry ejected from different die heads, and two-layer portions and single-layer portions can be formed with good dimensional precision. In case of coating a slurry with one die head and forming active material layer with consecutive thinned portions and stepped portions, it is necessary to bring a die head into proximity with the current collector and then to distance from the current collector. On the other hand, such a complicated process is unnecessary in the present exemplary embodiment. It results in good working efficiency excellent dimensional precision.
Further, in the present exemplary embodiment, lower active material layer and upper active material layer can be formed by a plurality of die heads in parallel. Hence, its process-time becomes shorter than a previous process that coats a slurry with one die head and forming lower active material layer followed by upper active material layer step by step.

In the present exemplary embodiment as described hereinabove, the lower active material layer of the preceding electrode and the lower active material layer of the next electrode are formed by the slurry ejection from die head 15a located on the most upstream side and die head 15b located on the second from the upstream side, and the upper active material layer of the preceding electrode and the upper active material layer of the next electrode are formed by the slurry ejection from die head 15c located on the third from the upstream side and the slurry ejection from die head 15d located on the fourth die head from the upstream side. The third and the fourth die heads 15c and 15d form upper active material layers on lower active material layers that have already been formed, and these die heads are therefore arranged with a gap from the current collector. Accordingly, the distance between current collectors 9, 11 and die head 15c and the distance between current collectors 9, 11 and die head 15d are longer than the distance between current collectors 9, 11 and die head 15a and the distance between current collectors 9, 11 and die head 15b. In one example, die head 15a and die head 15b eject slurry simultaneously, and die head 15c and die head 15d eject slurry simultaneously, and the working efficiency can thus be raised. However, the present invention is not limited to this method and various modifications can be considered. Although not shown in the figures, upper active material layer 10b₁ of the preceding electrode may be formed by the ejection of slurry from die head 15c, and upper active material layer 10b₂ of the next electrode may be formed by the ejection of slurry from die head 15d. Although not shown in the figures, lower active material layer 10a₁ of the preceding electrode may be formed by the ejection of slurry from die head 15a, and lower active material layer 10a₂ of the next electrode may be formed by the ejection of slurry from die head 15b.

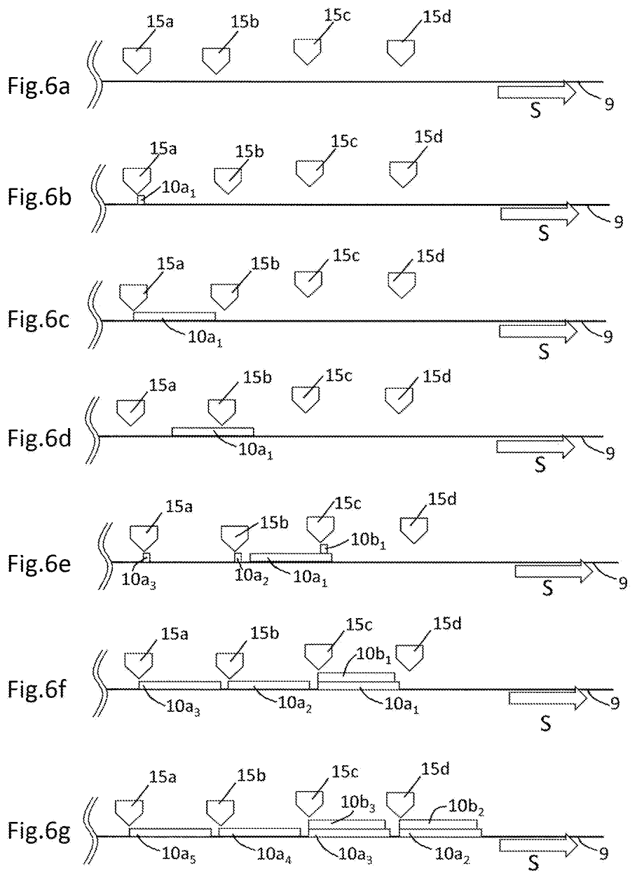

In the modifications shown in FIGS. 6a-6g, positive electrode current collector 9 is conveyed as shown in FIG. 6a, and slurry is ejected from die head 15a to form lower active material layer 10a₁ of the preceding electrode as shown in FIG. 6b. Current collector 9 is conveyed as shown in FIGS. 6c-6e, and when lower active material layer 10a₁ of the preceding electrode reaches the opposite position of die head 15c, slurry is simultaneously ejected from the first to the third die heads 15a-15c as shown in FIGS. 6e-6f. Upper active material layer 10b₁ of the preceding electrode is formed by the ejection of slurry from die head 15c and lower active material layer 10a₂ of the next electrode is formed by the ejection of slurry from die head 15b. At that time, lower active material layer 10a₃ of the electrode after the next can also be simultaneously formed by the ejection of slurry from die head 15a of the most upstream side. Current collector 9 is further conveyed, and when lower active material layer 10a₂ of the next electrode is opposite die head 15d, upper active material layer 10b₂ is formed on lower active material layer 10a₂ of the next electrode by the ejection of slurry from die head 15d as shown in FIG. 6g. At that time, the simultaneous ejection of slurry from die heads 15a-15c enables not only the formation of upper active material layer 10b₃ on lower active material layer 10a₃ of the following electrode but also the formation of lower active material layers 10a₄ and 10a₅ of the succeeding electrodes at same time, whereby good working efficiency is achieved.

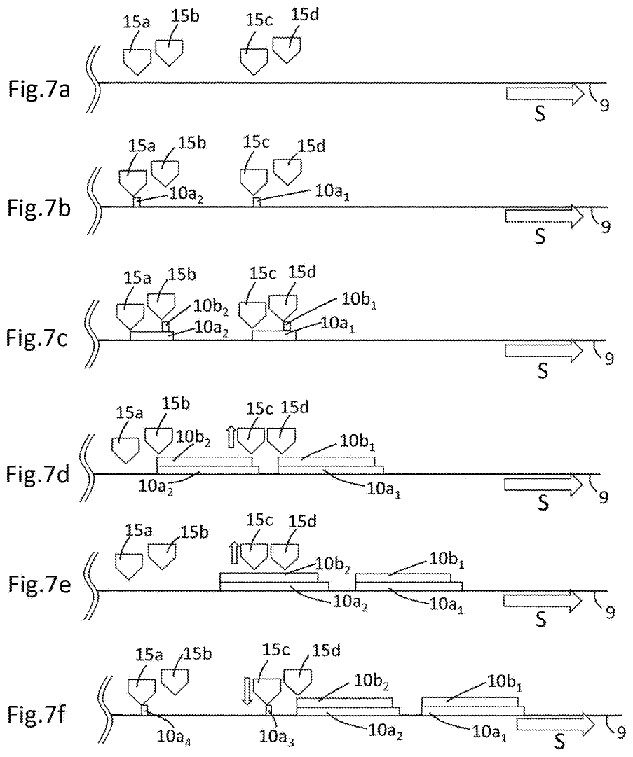

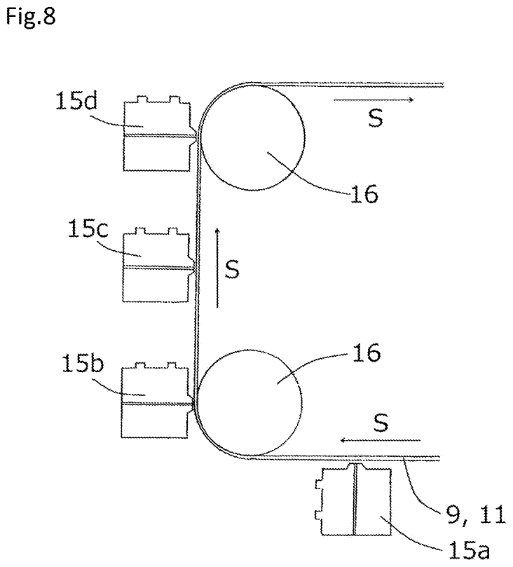

In the exemplary embodiment shown in FIGS. 7a-7f, the ejection of slurry from, of four die heads 15a-15d, die head 15c, forms lower active material layer 10a₁ of the preceding electrode and the ejection of slurry from die head 15d forms upper active material layer 10b₁ of the preceding electrode. And the ejection of slurry from die head 15a forms lower active material layer 10a₂ of the next electrode, and the ejection of slurry from die head 15b, forms upper active material layer 10b₂ of the next electrode.

More specifically, positive electrode current collector 9 is conveyed as shown in FIG. 7a, the ejection of slurry from die head 15c forms lower active material layer 10a₁ of the preceding electrode, and the ejection of slurry from die head 15a forms upper active material layer 10a₂ of the next electrode, as shown in FIG. 7b. Next, each of lower active material layer 10a₁ and 10a₂ is conveyed to opposite positions of die head 15d and die head 15b, respectively, and current collector 9 is conveyed a distance that corresponds to the length of the single-layer portions. As shown in FIGS. 7c-7d, the ejection of slurry from die head 15d forms upper active material layer 10b₁ of the preceding electrode, and the ejection of slurry from die head 15b forms upper active material layer 10b₂ of the next electrode. After current collector 9 is conveyed as shown in FIG. 7e, the ejection of slurry from die head 15c, and the ejection of slurry from die head 15a, form lower active material layers 10a₃ and 10a₄ of the two succeeding electrodes.

According to this method, die head 15a and die head 15b can be arranged in proximity in the direction of conveyance S, and similarly, die head 15c and die head 15d can be arranged in proximity. Accordingly, the coating device can be constructed more compact. In this configuration, die heads 15b and 15d are arranged at a distance from the current collector to form upper active material layers on the lower active material layers that have already been formed. Therefore, the distance between current collector 9 and die head 15c and the distance between die head 15d are both longer than the distance between current collectors 9, 11 and die head 15a. Die head 15c must be separated from current collector 9 so as not to collide with the upper active material layer, but must be in proximity with current collector 9 to form the lower active material layer. Consequently, as shown by the arrows in FIGS. 7d-7f, die head 15c is movable and the distance between die head 15c and current collectors 9, 11 can be varied. Although not shown in the figures, the ejection of slurry from die head 15a may form lower active material layer 10a₁ of the preceding electrode, die head 15b may form upper active material layer 10b₁ of the preceding electrode, the ejection of slurry from die head 15c may form lower active material layer 10a₂ of the next electrode, and the ejection of slurry from die head 15d may form upper active material layer 10b₂ of the next electrode.

The coating device used in the various manufacturing methods described above is not limited to the configuration shown in FIG. 4. For example, the die heads are not necessarily arranged at points where back rolls are present. All or a portion of the die heads may be arranged in spaces between back rolls or at points at which the current collector foil is floating in the spaces between the conveyance rollers (not shown in the figures). The coating device should be configured such that at least four die heads 15a-15d are arranged in a row along the direction of conveyance of current collector 9 and all four heads are also arranged at positions that face current collector 9. Alternatively, the present invention may be of a configuration that has five or more die heads shown in FIGS. 5a-7f.

After the above described active material layers of two-layer structure are formed shown in FIGS. 2 and 3, tape type insulating members are pasted to the boundary portions of coated portions and non-coated portions on one or both of positive electrodes 2 and negative electrodes 3, and more specifically, put on the boundary of single-layer portions in which only the lower active material layer of the active material layers is present and portions of current collectors in which the active material layer is not formed. In the present exemplary embodiment, insulating members 20 are pasted to only positive electrodes 2 as shown in FIG. 2. The thickness of insulating members 20 is substantially equal to or less than the thickness of upper active material layer 10a, and as a result, the thickness of all electrodes 2 is substantially equal and the thickness does not increase locally even at the points where insulating members are arranged.

As shown in FIGS. 1a and 1b, these positive electrodes 2 and negative electrodes 3 are alternately laminated on each other with separators 4 interposed therebetween and connected to positive electrode terminal 7 and negative electrode terminal 8. More specifically, the positive electrode current collectors 9 of a plurality of positive electrodes 2 are superimposed in close contact on one end portion of positive electrode terminal 7, and a metal tab 13 is further arranged on these parts, whereupon these parts are gathered together and joined. Although there is a plurality of methods of joining the electrode tabs and electrode terminal, joining by ultrasonic welding is usually adopted. In other words, ultrasonic welding can be affected by pressing a horn and anvil (not shown in the figure) against each of positive electrode terminal 7 and support tab 13 that clasp a plurality of positive electrode current collectors and then applying vibration while applying pressure. In negative electrodes 3, a collection portion in which a plurality of negative electrode current collectors 11 are superimposed is clasped by metal tab 13 and negative electrode terminal 8 then subjected to ultrasonic welding as well as above described methods of manufacturing positive electrodes 2.

In this way, the multilayered electrode body 17 is manufactured by connecting positive electrode terminal 7 to the non-coated portions of positive electrodes 2, i.e. positive electrode current collectors 9 and, by connecting negative electrode terminal 8 to the non-coated portions of negative electrodes 3 i.e. negative electrode current collectors 11. Then the principal surfaces of the multilayered electrode body 17 is covered from above and below by flexible film 6. Excepting one portion, pressure and heat are then applied to, the portions in which flexible film 6 overlaps at the outer sides of the outer periphery of multilayered electrode body 17 as seen planarly. Then the resin layer 6b on the inner sides of flexible film 6 is thermally fused and joined together. At that time, positive electrode terminal 7 and negative electrode terminal 8 is fixed to the outer periphery of flexible film 6 by way of sealant 18 that has been provided beforehand. On the other hand, of the portions in which flexible film 6 overlaps, the portion to which pressure and heat have not been applied remains as an open portion and used as injection port at the following step. Typically, an injection port is formed in a portion of any one side of the sides of outer case 14 excepting the side in which positive electrode terminal 7 is arranged and the side in which negative electrode terminal 8 is arranged. Electrolyte 5 is then injected into the interior of outer case 14 from the injection port. The sides other than the injection port have already been sealed, and electrolyte 5 therefore does not leak. Further, electrolyte 5 does not infiltrate portions in which flexible film 6 overlaps itself. Pressure and heat is then applied to the injection port and the resin layer 6b of the inner side of flexible film 6 is thermally fused and joined together. Secondary battery that is an example of an electrochemical device is thus completed.

The present invention is particularly useful in a lithium-ion secondary battery, but the present invention is also effective when applied to secondary batteries other than lithium-ion batteries or electrochemical devices other than batteries such as capacitors or condensers.

While the invention has been particularly shown and described with reference to exemplary embodiments thereof, the invention is not limited to these exemplary embodiments.

It will be understood by those of ordinary skill in the art that various changes in form and details may be made therein without departing from the spirit and scope of the present invention as defined by the claims.

This application claims the benefits of priority based on Japanese Patent Application No. 2016-48838 for which application was submitted on Mar. 11, 2016 and incorporates by citation all the disclosures of Japanese Patent Application No. 2016-48838.

### EXPLANATION OF THE REFERENCE NUMBER

1 secondary battery
2 positive electrode
3 negative electrode
4 separator
5 electrolyte
6 flexible film
7 positive electrode terminal
8 negative electrode terminal
9 positive electrode current collector
10 positive electrode active material layer
10a, 10a₁-10a₅ upper active material layer
10b, 10b₁-10b₅ lower active material layer
11 negative electrode current collector
12 negative electrode active material layer
12a upper active material layer
12b lower active material layer
13 metal tab
14 outer case
15a-15d die head
16 roll
17 multilayered electrode body
18 sealant
19 cutting line
20 insulating member

1. A method of manufacturing electrodes of an electrochemical device;
the electrode comprising
a plurality of current collectors and
a plurality of active material layer formed on the current collector;
the active material layers comprising
a lower active material layer formed on the current collector and
an upper active material layer formed on the lower active material layer;
the manufacturing method comprising:
using at least four die heads arranged in a row along the direction of conveyance of the current collector and arranged onto the current collector surface; and
while conveying the current collector,
forming the lower active material layers of two electrodes by ejecting an active material-containing slurry onto the current collector from the die head located on the most upstream side in the direction of conveyance and ejecting the slurry onto the current collector from the die head located on the second from the upstream side in the direction of conveyance; and
forming the upper active material layers of the two electrodes by ejecting the slurry onto the current collector from the die head located on the third from the upstream side in the direction of conveyance and ejecting the slurry onto the current collector from the die head located on the fourth from the upstream side of the direction of conveyance.

2. The method of manufacturing electrodes for an electrochemical device according to claim 1, comprising:
forming the lower active material layer of a preceding electrode by ejecting the slurry onto the current collector from the die head located on the second from the upstream side in the direction of conveyance and
forming the lower active material layer of a next electrode by ejecting the slurry onto the current collector from the die head located on the most upstream side in the direction of conveyance; and
forming the upper active material layer of the preceding electrode by ejecting the slurry onto the current collector from the die head located on the fourth from the upstream side in the direction of conveyance and
forming the upper active material layer of the next electrode by ejecting the slurry onto the current collector from the die head located on the third from the upstream side in the direction of conveyance.

3. The method of manufacturing electrodes for an electrochemical device according to claim 1, comprising:
forming the lower active material layer of a preceding electrode by ejecting the slurry onto the current collector from the die head located on the most upstream side in the direction of conveyance and
forming the lower active material layer of a next electrode by ejecting the slurry onto the current collector from the die head located on the second from the upstream side in the direction of conveyance; and
forming the upper active material layer of the preceding electrode by ejecting the slurry onto the current collector from the die head located on the fourth from the upstream side in the direction of conveyance and
forming the upper active material layer of the next electrode by ejecting the slurry onto the current collector from the die head located on the third from the upstream side in the direction of conveyance.

4. The method of manufacturing electrodes of an electrochemical device according to claim 1, comprising:
forming the lower active material layer of a preceding electrode by ejecting the slurry onto the current collector from the die head located on the most upstream side in the direction of conveyance and
forming the lower active material layer of a next electrode by ejecting the slurry onto the current collector from the die head located on the second from the upstream side in the direction of conveyance; and
forming the upper active material layer of the preceding electrode by ejecting the slurry onto the current collector from the die head located on the third from the upstream side in the direction of conveyance and
forming the upper active material layer of the next electrode by ejecting the slurry onto the current collector from the die head located on the fourth from the upstream side in the direction of conveyance.

5. The method of manufacturing electrodes for an electrochemical device according to claim 1, wherein:
the distance between the current collector and the die head located on the third from the upstream side in the direction of conveyance and the distance between the current collector and the die head located on the fourth from the upstream side in the direction of conveyance are longer than the distance between the current collector and the die head located on the most upstream side in the direction of conveyance and the distance between the current collector and the die head located on the second from the upstream side in the direction of conveyance.

6. A method of manufacturing electrodes of an electrochemical device;
the electrode comprising a plurality of current collectors and a plurality of active material layer formed on the current collector;
the active material layers comprising
a lower active material layer formed on the current collector and
an upper active material layer formed on the lower active material layer;
the manufacturing method comprising:
using at least four die heads arranged in a row along the direction of conveyance of the current collector and onto the current collector surface; and
while conveying the electrode,
forming the lower active material layer of one electrode by ejecting the slurry onto the current collector from the die head located on the third from the upstream side in the direction of conveyance,
forming the upper active material layer of the one electrode by ejecting the slurry onto the current collector from the die head located on the fourth from the upstream side in the direction of conveyance; and
forming the lower active material layer of the other electrode by ejecting slurry that contains the active material onto the current collector from the die head located on the most upstream side in the direction of conveyance, and
forming the upper active material layer of the other electrode by ejecting the slurry onto the current collector from the die head located on the second from the upstream side in the direction of conveyance.

7. The method of manufacturing electrodes for an electrochemical device according to claim 6, wherein:
the distance between the current collector and the die head located on the second from the upstream side in the direction of conveyance and the distance between the current collector and the die head located on the fourth from the upstream side in the direction of conveyance are longer than the distance between the current collector and the die head located on the most upstream side in the direction of conveyance; and
the distance between the current collector and the die head located on the third from the upstream side in the direction of conveyance is variable.

8. The method of manufacturing electrodes for an electrochemical device according to claim 1, wherein:
the coating start point of the upper active material layer is positioned on the lower active material layer, and
the active material layer comprises a two-layer portion in which the lower active material layer and the upper active material layer is stacked and
a single-layer portion that is made up from the lower active material layer and the upper active material layer is not present.

9. The method of manufacturing electrodes for an electrochemical device according to claim 8, wherein:
an insulating member is put on a boundary of the single-layer portion and the non-coated portion in which the active material layer is not formed on the current collector.

10. The method of manufacturing electrodes for an electrochemical device according to claim 9, wherein
the thickness of the upper active material layer is equal to the thickness of the insulating member.

11. The method of manufacturing electrodes for an electrochemical device according to claim 1, wherein
the slurry contains at least the active material and a binder.

12. A method of manufacturing an electrochemical device comprising:
manufacturing either one or both of positive electrodes and negative electrodes by the method of manufacturing electrodes for an electrochemical device according to claim 1;
forming a multilayered electrode body by alternately laminating the positive electrode and the negative electrode on each other with a separator interposed therebetween; and
accommodating the multilayered electrode body and electrolyte inside an outer case.

13. The method of manufacturing electrodes for an electrochemical device according to claim 6, wherein:
the coating start point of the upper active material layer is positioned on the lower active material layer, and
the active material layer comprises a two-layer portion in which the lower active material layer and the upper active material layer is stacked and
a single-layer portion that is made up from the lower active material layer and the upper active material layer is not present.

14. The method of manufacturing electrodes for an electrochemical device according to claim 13, wherein
an insulating member is put on a boundary of the single-layer portion and the non-coated portion in which the active material layer is not formed on the current collector.

15. The method of manufacturing electrodes for an electrochemical device according to claim 14, wherein
the thickness of the upper active material layer is equal to the thickness of the insulating member.

16. The method of manufacturing electrodes for an electrochemical device according to claim 6, wherein
the slurry contains at least the active material and a binder.

17. A method of manufacturing an electrochemical device comprising:
manufacturing either one or both of positive electrodes and negative electrodes by the method of manufacturing electrodes for an electrochemical device according to claim 6;
forming a multilayered electrode body by alternately laminating the positive electrode and the negative electrode on each other with a separator interposed therebetween; and
accommodating the multilayered electrode body and electrolyte inside an outer case.
